(19) United States
(12) Patent Application Publication
(10) Pub. No.: US 2009/0200690 A1
(43) Pub. Date: Aug. 13, 2009

(54) Mass Transfer Device

(76) Inventors: Bogdan Vladimirovich Maleta, Kievskaya obl. (UA); Olesja Vladimirovna Maleta, Kievskaya obl. (UA)

Correspondence Address: Aleksandr Smushkovich, Post Office Box 140505, Brooklyn, NJ, 11214, US

(21) Appl. No.: 12/227,991

(22) PCT Filed: Jun. 7, 2007
(86) PCT No.: PCT/UA2007/000038

§ 371 Date: Dec. 4, 2008

(30) Foreign Application Priority Data
Jun. 13, 2006 (UA) A 2006 06612

(51) Int. Cl. B01D 3/26; B01D 3/20

(52) U.S. Cl. 261/114.4

(57) ABSTRACT

A mass-exchange contact device is proposed, comprising: upper and lower flat ring-shaped trays outwardly attached to a column, a sleeve including sidewalls attached to the trays and having windows made therein with bottom edges in the plane of the lower tray, a barbotage unit connected to the top of sleeve and having orifices in its sidewalls, a movable double-acting valve including two upper and lower plates attached to a rod axially disposed therebetween. The top of barbotage unit includes an ascending limiter of valve's movement, the bottom of sleeve includes a descending limiter of the valve's movement. In some embodiments, the barbotage unit is made as a portion of the sleeve. The height of windows preferably is equal to the height of valve. The proposed design significantly improves device operation for a cyclic mode, reliability, durability, reduces its weight and cost, extends its operational range for steam and liquid loads.

### CROSS-REFERENCE TO RELATED APPLICATIONS

This application is a U.S. national phase application of a PCT application PCT/UA2007/000038 filed on 7 Jun. 2007, published as WO2007/145604, whose disclosure is incorporated herein in its entirety by reference, which PCT application claims priority of a Ukrainian patent application UA2006/06612 filed on 13 Jun. 2006.

### FIELD OF THE INVENTION

The invention is related to mass-exchange devices, namely to the devices intended for conducting mass-exchange processes in gas (steam)—liquid phase systems under conditions of a cyclical regime (where there are provided separate movements of the phases in a column). It can be used in the food, chemical, petrochemical, oil-processing, and other industries.

### BACKGROUND OF THE INVENTION

There is known a mass-exchange contact device, comprising a tray with a contact element, a ring, a movable double-acting valve, ascending and descending limiters. The ring along its perimeter has a plurality of vertically extended holes, and the movable double-acting valve is formed by a plurality of solid plates stacked one above the other. The device is equipped with an additional tray.

The ascending limiter is represented by the contact element, and the descending limiter is represented by the lower edge of the ring. The lower edges of the holes of ring are arranged at the level of the additional tray. The contact element is configured as an inner cap with a plurality of barbotage unit plates tangentially bent out, wherein the height of the ring is equal to the height of the double-acting valve, and one of the valve's plates divides the cross-section of the holes into equal sectors in the ending positions of the valve (RU2237508).

A disadvantage of the above-described device is that the barbotage unit has a fixed free cross-section that causes a shift of the operation range to the side of increased steam expenditure under insubstantial liquid loads. Another disadvantage is its excessive height (the distance between the main and additional trays) that leads to an increase of the column's height and its metal content that involves additional costs.

### BRIEF DESCRIPTION OF THE INVENTION

The primary aim of the present invention is the improvement of known mass exchange contact devices, namely: an extension of the steam load operating range, reduction of the metal content (amount of metal consumed for making the device), the height, and costs of the device, increasing the reliability and durability of device operation. Other aims of the invention may become apparent to a skilled artisan upon learning the present disclosure.

The aforesaid aim is achieved by providing a specially designed mass-exchange contact device comprising: an essentially flat ring-shaped upper tray attached with its outward edge to a rectification column's walls; a cylindrical sleeve attached to the inward edge of the upper tray, the sleeve includes a top opening, and a bottom opening with a ring-shaped descending limiter surrounding the bottom opening, the sleeve includes a plurality of vertically extended windows made in its sidewalls so that the top edges of the windows are situated at the plane of upper tray, the sleeve is attached to the inward edge of the upper tray; a cylindrical barbotage unit disposed immediately above the plane of upper tray and coupled with the top edge of the sleeve 4, the barbotage unit includes a ring-shaped ascending limiter surrounding its top opening thereof, the barbotage unit includes a plurality of orifices on its sidewalls (in alternative embodiments, the barbotage unit is made as a portion of the sleeve); an essentially flat ring-shaped lower tray outwardly attached to the column and inwardly attached to the sleeve, the lower tray is situated at the plane of the bottom edges of the windows; a movable double-acting (two-way or bidirectional) valve including a lower flat disc-shaped plate and an upper flat disc-shaped plate, both the plates are slidely fitted into the sleeve, the valve also includes a rod axially connecting the centers of upper and lower plates, the upward movement of the valve is restricted by the ascending limiter, and the downward movement of the valve is restricted by the descending limiter; wherein the upper plate functions as a contact element between the steam and the liquid phases. In a preferred embodiment, the height of the windows is chosen equal to the height of the double-acting valve.

The proposed design of the mass-exchange devices provides the intended technical result due to the following:

1) The invented device has a technological advantage of the valve-tray stationary process, namely: reducing the free cross-section of the barbotage unit with decreasing steam expenditure. This allows maintaining a substantially constant pressure difference on the tray that causes the double-acting valve to be in the upper position.

2) While steam flows upward under the upper plate of the valve, the device utilizes the dynamical pressure of steam as an additional force for maintaining the valve in the upper position.

3) The reduction of the height of device by 30% can be achieved in the proposed design that allows reducing the column's metal content by 10% resulting in significant cutting its cost.

4) During a smooth shutting the steam flow, the valve moving downward decelerates at the level of orifices on the sidewalls of the barbotage unit, and mildly and strikelessly lowers on the descending limiter, which prolongs the service life of the device.

### BRIEF DESCRIPTION OF THE DRAWINGS

The invention is illustrated in the following drawings:

FIG. 1 is a view showing the mass exchange contact device at an initial moment of supplying steam according to a preferred embodiment of the present invention;

FIG. 2 is a view showing the device at the moment of altering the exertion of lifting force from the lower plate to the upper plate of the valve, according to the preferred embodiment shown on FIG. 1;

FIG. 3 is a view showing the mass exchange contact device at a position corresponding to the subsequent moments of supplying steam according to the preferred embodiment shown on FIG. 1.

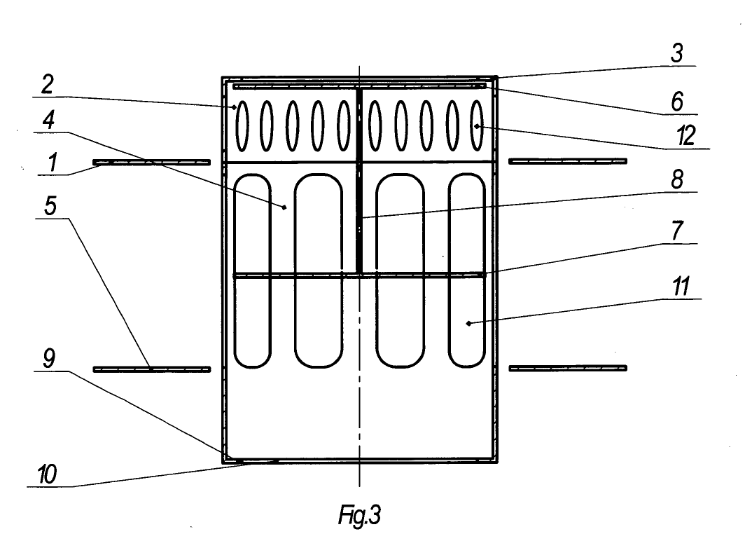

Each reference numeral indicated on the drawings is designated to an element of the inventive structure described herein below. A first time introduced reference numeral in the description is enclosed into parentheses.

### DETAIL DESCRIPTION OF THE PREFERRED EMBODIMENT

While the invention may be susceptible to embodiment in different forms, there are described in detail herein below, specific embodiments of the present invention, with the understanding that the present disclosure is to be considered an exemplification of the principles of the invention, and is not intended to limit the invention to that as illustrated and described herein.

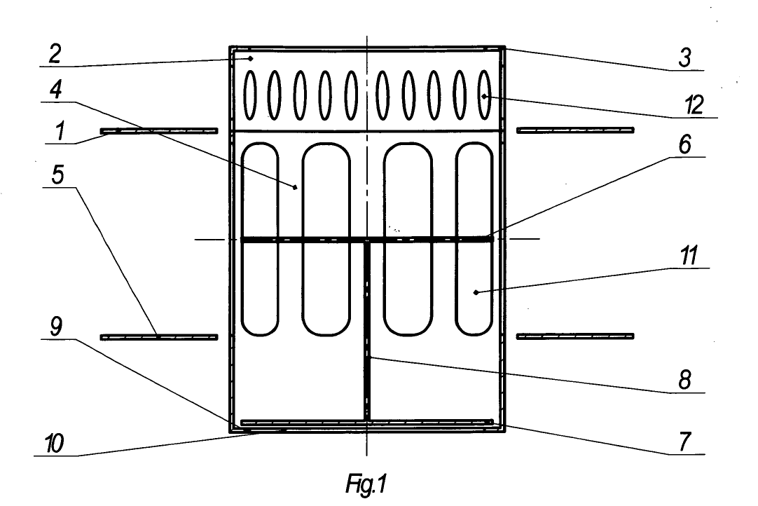

As illustrated on FIGS. 1,2,3, the inventive mass-exchange contact device comprises an essentially flat ring-shaped upper tray (1) attached with its outward edge to the walls of a conventional rectification column (not illustrated).

The inventive device comprises a cylindrical sleeve (4) attached to the inward edge of the upper tray 1, the sleeve 4 includes a top opening with a ring-shaped ascending limiter (3) surrounding the top opening, and a bottom opening (10) with a ring-shaped descending limiter (9) surrounding the bottom opening. The limiters 3 and 9 can be made as folded edges of the sleeve 4. The sleeve 4 includes a plurality of vertically extended windows (11) made in its sidewalls so that the top edges of the windows 11 are situated in the plane of upper tray 1. The sidewalls of sleeve 4 in their upper region are attached to the inward edge of the upper tray 1.

The inventive device comprises a barbotage unit (2) disposed immediately above the plane of upper tray 1. The barbotage unit 2 has a cylindrical shape with an open top and an open bottom connected with the top opening of the sleeve 4. The barbotage unit 2 includes a plurality of orifices (12) on its sidewalls. In alternative embodiments (not illustrated), the barbotage unit is made as a portion of the sleeve 4.

The inventive device comprises an essentially flat ring-shaped lower tray (5) outwardly attached to the column and inwardly attached to the lower portion of sidewalls of the sleeve 4. The lower tray 5 is situated in the plane of the bottom edges of the windows 11. The tray 1, the corresponding side portion of the column, and the tray 5 form a closed space (‘transitional space’) for receiving steam during operation of the device.

The inventive device comprises a movable double-acting (two-way or bidirectional) valve including a lower flat disc-shaped solid plate (7) and an upper flat disc-shaped solid plate (6), the plates 6 and 7 are slidely fitted into the sleeve 4. The valve includes a rigid distance rod (8) axially connecting the centers of the upper plate 6 and lower plate 7. The upward movement of the valve is restricted by the ascending limiter 3, and the downward movement of the valve is restricted by the descending limiter 9; wherein the upper plate 6 functions as a contact element between the steam and the liquid phases.

In a preferred embodiment, the height of the windows 11 is chosen equal to the height of the double-acting valve. A rectification column may contain a predetermined number of such mass-exchange devices.

The inventive device operates in the following manner: at a ‘steam’ period of the process, the pressure of the steam (gas) phase lifts the double-acting valve up to the upper position, so that the upper plate 6 shuts the top of barbotage unit 2, which upper plate 6 is functioning at the moment as a contact element between the steam and liquid phases. The steam flow, passing under the plate 6, via the orifices 12 interacts with the liquid situated on the tray 1.

At the end of the ‘steam’ period, the valve moves down under the action of its own weight and the weight of liquid, decelerates at the level of tray 1, and mildly descends on the limiter 9. The delay time for the steam flow is determined by the time necessary for transfer of the liquid portion from the tray 1 into the transitional space, and is about several seconds.

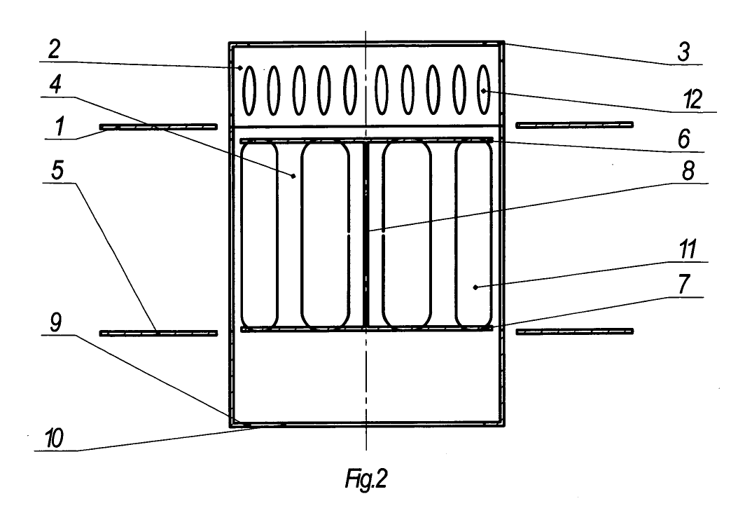

At the initial moment of action of steam, a lifting force is upwardly exerted to the lower plate 7 caused by a pressure difference (FIG. 1). At the moment when the plate 7 is lifted to the level of tray 5 (bottom edge of the windows 11), the lifting force changes its point of application, and is exerted to the upper plate 6 (FIG. 2), while the maximum possible pressure difference is still kept. The steam flow passes the orifices 12, and barbotates through the liquid.

Since the passing cross-sections of the windows 11 are increased during the process, the speed of steam flow decreases that facilitates a transfer of liquid to the mass-exchange device situated below the given device in the column. Meanwhile, the valve moves up to the most upper position determined by the level of limiter 3. The weight of the valve and the portion of liquid thereupon must be less than the pressure difference force applied to the upper plate 6.

The time of liquid transfer from the given mass-exchange device to the one located below in the column is called a ‘liquid’ period. The cycles consisting of the ‘steam’ and ‘liquid’ periods are analogously repeated.

The proposed design of the device allows conducting mass-exchange processes in a steam (gas)—liquid system in a cyclical mode under one-time delay of liquid simultaneously in all mass-exchange devices of a column, extending the operating range of liquid and steam loads, increasing the productivity, reliability, and durability of the devices. Application of such mass-exchange contact devices removes the necessity of intermingling the liquid on the contact adjacent stages and allows rising the mass-exchange effectiveness by two-three times comparatively with a stationary process.

1-2. (canceled)

3. A mass-exchange contact device for mass-exchange of the steam and liquid phases in a conventional rectification column, said device comprising:
an essentially flat ring-shaped upper tray outwardly attached to the walls of the column;
a cylindrical sleeve attached to the inward edge of said upper tray, said sleeve including a top opening with an ascending limiter, and a bottom opening with a descending limiter;
said sleeve including a plurality of windows made in its sidewalls so that the top edges of said windows are situated in the plane of said upper tray, the upper portion of said sleeve's sidewalls is attached to the inward edge of said upper tray;
a barbotage unit disposed above the plane of said upper tray; said barbotage unit having a cylindrical shape with an open top and an open bottom connected with the top opening of said sleeve, said barbotage unit including a plurality of orifices on its sidewalls;
an essentially flat ring-shaped lower tray outwardly attached to the column and inwardly attached to the lower portion of said sleeve's sidewalls, said lower tray is situated in the plane of the bottom edges of said windows; and
a movable double-acting valve including a lower flat disc-shaped solid plate and an upper flat disc-shaped solid plate, said lower and upper plates are slidely fitted into said sleeve, said valve including a distance rod axially connecting the centers of said lower and upper plates;
wherein the upward movement of said valve is restricted by said ascending limiter, and the downward movement of said valve is restricted by said descending limiter, and said upper plate functions as a contact element between the steam and the liquid phases.

4. The mass-exchange contact device according to claim 3, wherein the height of said windows is equal to the height of said valve.

5. A mass-exchange contact device for mass-exchange of the steam and liquid phases in a conventional rectification column, said device comprising:
an essentially flat ring-shaped upper tray outwardly attached to the walls of the column;
a cylindrical sleeve attached to the inward edge of said upper tray, said sleeve including a bottom opening with a descending limiter; said sleeve including a plurality of windows made in its sidewalls so that the top edges of said windows are situated in the plane of said upper tray, the upper portion of said sleeve's sidewalls is attached to the inward edge of said upper tray; said sleeve including a barbotage portion disposed in the top region of said sleeve above the plane of said upper tray, said barbotage portion having a cylindrical shape with an open top coupled with an ascending limiter, said barbotage portion including a plurality of orifices on its sidewalls;
an essentially flat ring-shaped lower tray outwardly attached to the column and inwardly attached to the lower portion of said sleeve's sidewalls, said lower tray is situated in the plane of the bottom edges of said windows; and
a movable double-acting valve including a lower flat disc-shaped solid plate and an upper flat disc-shaped solid plate, said lower and upper plates are slidely fitted into said sleeve, said valve including a distance rod axially connecting the centers of said lower and upper plates;
wherein the upward movement of said valve is restricted by said ascending limiter, and the downward movement of said valve is restricted by said descending limiter, and said upper plate functions as a contact element between the steam and the liquid phases.

6. The mass-exchange contact device according to claim 5, wherein the height of said windows is equal to the height of said valve.
